(19) United States
(12) Patent Application Publication
(10) Pub. No.: US 2017/0308829 A1
(43) Pub. Date: Oct. 26, 2017

(54) METHOD, SYSTEM AND COMPUTER PROGRAM PRODUCT FOR MANAGING HEALTH CARE RISK EXPOSURE OF AN ORGANIZATION

(71) Applicant: LeanTaas, Santa Clara, CA (US)

(72) Inventors: Ji LI, Mountain View, CA (US); Jayant LAKSHMIKANTHAN, San Jose, CA (US)

(21) Appl. No.: 15/488,380

(22) Filed: Apr. 14, 2017

Related U.S. Application Data
(60) Provisional application No. 62/325,960, filed on Apr. 21, 2016.

(51) Int. Cl. G06Q 10/06; G06F 19/00; G06Q 50/24; G06Q 40/08

(52) U.S. Cl. CPC G06Q 10/0635; G06Q 50/24; G06Q 40/08; G06F 19/322; G06F 19/328; G06F 19/36

(57) ABSTRACT

Method, system and computer program product for facilitating management of health care risk exposure of an organization are disclosed. The method includes receiving a plurality of records associated with an organization from one or more data sources. Each record includes data corresponding to a health related adverse event. The data is received in a structured form. A set of composite documents is generated from the plurality of records. Each composite document includes information in an unstructured form. If the set of composite documents include instances of duplication of information, then events are created for the instances of duplication of information. The method further includes classifying the created events using a predetermined taxonomy and analyzing the events to facilitate assessment and management of health care risk exposure of the organization.

### TECHNICAL FIELD

The present technology generally relates to risk management and, more particularly, to a method, system and computer program product for managing health care risk exposure of an organization.

### BACKGROUND

Risk management is the process of identifying, quantifying and managing the risks that an organization may face. Risk Managers currently use several heterogeneous data sets to evaluate risk. Evaluating an organization's health care risk exposure, such as for example evaluating risks related to medical malpractice or worker's compensation actions, is difficult as the data is stored across several disparate data sets and combining such data sets is complicated as the data sets do not have a clear identity connecting them.

In view of the above, there is a need to combine heterogeneous data sets and provide the organization with a consolidated view of their health care risk exposure.

### SUMMARY

Various embodiments of the present disclosure provide a method, system and a computer program product for facilitating management of health care risk exposure of an organization.

In an embodiment, a computer-implemented method for facilitating management of health care risk exposure of an organization is disclosed. The method receives, by a processor, a plurality of records associated with an organization from one or more data sources. Each record from among the plurality of records includes data corresponding to a health related adverse event. The data is received in a structured form. The method generates, by the processor, a set of composite documents from the plurality of records. Each composite document from among the set of composite documents includes information in an unstructured form. The method determines, by the processor, if the set of composite documents includes instances of duplication of information. The method creates, by the processor, events corresponding to the instances of duplication of information if the set of composite documents is determined to include instances of duplication of information. The method classifies, by the processor, each event from among the created events using a predetermined taxonomy. The method analyzes, by the processor, the events classified using the predetermined taxonomy to facilitate assessment and management of health care risk exposure of the organization.

In an embodiment, a system for facilitating management of health care risk exposure of an organization is disclosed. The system includes a communication interface, a document generator, a duplicate document identifier, an event creator, a taxonomy classifier and an event analyzer. The communication interface is configured to receive a plurality of records associated with an organization from one or more data sources. Each record from among the plurality of records includes data corresponding to a health related adverse event. The data is received in a structured form. The document generator is configured to receive the plurality of records from the communication interface and generate a set of composite documents. Each composite document from among the set of composite documents includes information in an unstructured form. The duplicate document identifier is configured to determine if the set of composite documents includes instances of duplication of information. The event creator is configured to create events corresponding to the instances of duplication of information if the set of composite documents is determined to include instances of duplication of information by the duplicate document identifier. The taxonomy classifier is configured to classify each event from among the created events using a predetermined taxonomy. The event analyzer is configured to analyze the events classified by the taxonomy classifier to facilitate assessment and management of health care risk exposure of the organization.

In an embodiment, a computer program product for facilitating management of health care risk exposure of an organization is disclosed includes at least one computer-readable storage medium. The computer-readable storage medium includes a set of instructions, which, when executed by one or more processors, cause an electronic device to receive a plurality of records associated with an organization from one or more data sources. Each record from among the plurality of records includes data corresponding to a health related adverse event. The data is received in a structured form. The electronic device is caused to generate a set of composite documents from the plurality of records. Each composite document from among the set of composite documents includes information in an unstructured form. The electronic device is caused to determine if the set of composite documents includes instances of duplication of information. The electronic device is caused to create events corresponding to the instances of duplication of information if the set of composite documents is determined to include instances of duplication of information. The electronic device is caused to classify each event from among the created events using a predetermined taxonomy. The electronic device is caused to analyze the events classified using the predetermined taxonomy to facilitate assessment and management of health care risk exposure of the organization.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 is a block diagram representation showing a system in operative communication with a plurality of data sources, in accordance with an example embodiment;

FIG. 2 is a block diagram of a system configured to facilitate management of health care risk exposure of an organization, in accordance with an example embodiment;

FIG. 3 illustrates an example composite document generated by removing structure from one or more records by the document generator of the system of FIG. 2, in accordance with an example embodiment;

FIG. 4 illustrates a portion of an example taxonomy used for classifying the composite document of FIG. 3, in accordance with an example embodiment;

FIG. 5 is a flow diagram of a method for facilitating management of health care exposure risk of an organization, in accordance with an example embodiment;

FIG. 6 illustrates a server capable of implementing the various embodiments of the present disclosure; and

FIG. 7 illustrates a computing device capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

A method, system and a computer program product for managing health care risk exposure of an organization are provided.

The method includes receiving a plurality of records associated with an organization from one or more data sources. Each record includes data corresponding to a health related adverse event. For example, the records may correspond to health care related claims, complaints or incidents in a workplace setting related to the organization. Such records are stored in a structured from in various data sources. The plurality of records is received from the data sources and a set of composite documents is generated from the plurality of records. Each composite document includes information in an unstructured form. More specifically, structure is removed from individual records to generate freeform or a narrative style documents, referred to herein as a set of composite documents.

If the set of composite documents include instances of duplication of information, then events are created for the instances of duplication of information. The created events are classified using a predetermined taxonomy. For example, events may be classified using pre-defined rules and/or machine learning algorithms. The classified events may then be analyzed to facilitate assessment and management of health care risk exposure of the organization. For example, the insurance carriers may use the analysis of events to develop loss control programs for insured entities. In another example scenario, risk managers may use the analysis of events to isolate key sources of risk and develop intervention strategies for their respective organizations.

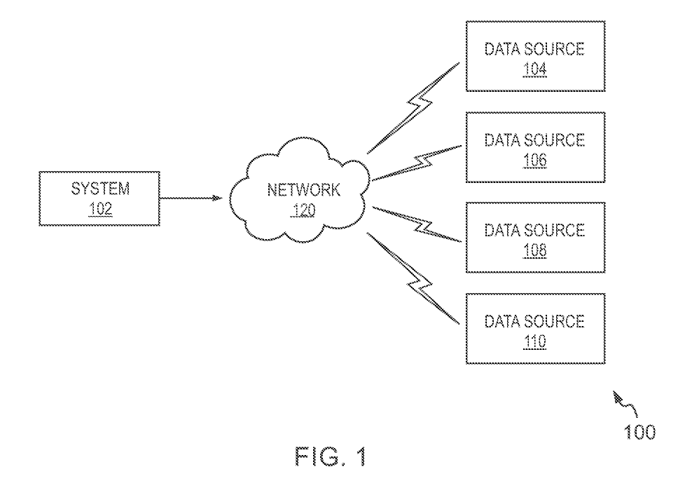

FIG. 1 is a block diagram representation 100 showing a system 102 in operative communication with a plurality of data sources, in accordance with an example embodiment. The system 102 may be configured to facilitate assessment and management of health care risk exposure of organizations. Some non-limiting examples of the organizations may include health care or medical care providers such as hospitals, enterprises involved in manufacturing goods (such as automobiles, aircraft parts or such complex mechanical components), enterprises involved in mining, construction and such other activities, and the like. In an embodiment, the organization may correspond to an insurance carrier. In some example embodiments, the organizations may include any public or private enterprise.

In an embodiment, the system 102 may be embodied as a risk mitigation platform in a Web server accessible over a communication network to various entities, such as insurance carriers, risk managers of organizations, third-party risk administrators, and the like. Such entities may access the system 102 to assess and manage health care risk exposure of an organization. In some embodiments, the system 102 may be embodied as a computing device, such as for example a workstation terminal or any portable electronic device.

In at least one embodiment, the system 102 may be in operative communication with a plurality of data sources, such as data sources 104, 106, 108 and 110. The term ‘operative communication’ as used herein refers to communication in form of requests and subsequent data transfer in response to the requests. For example, the system 102 may request risk related data corresponding to an organization from each data source. The data source in response to the received request may provision the data corresponding to the organization stored in their respective databases to the system 102. The system 102 may then provision an acknowledgement of the receipt of the data to each data source.

The plurality of data sources may store health care related data for an organization, such as reported claims, complaints, incidents at a workplace setting, and the like. For example, a data source may store data related to medical malpractice claims made by patients that their respective medical care was not appropriate and harmed them. Such claims may be as a result of missed medical diagnosis (i.e. either wrong diagnosis or a delayed diagnosis) that led to a materially worse patient outcome. Similarly, one data source may store data related to incidents that occurred at a workplace setting that triggered a worker's compensation action. To summarize, each record stored in the data sources corresponds to a health related adverse event (for example, a sickness, a disease, physical or mental condition requiring medical assistance, a work-related injury, and the like).

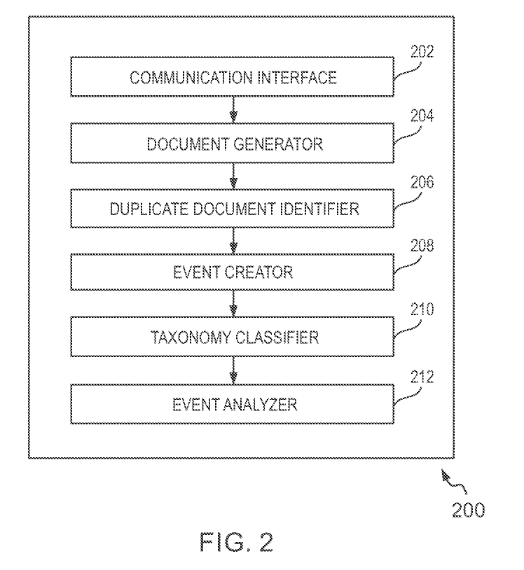

Each data source may store data as records in a structured format specific to that data source. The system 102, as will be explained in further detail with reference to FIG. 2, may include appropriate means for communication with the plurality of data sources to receive the records from the plurality of data sources over a communication network, such as a network 120. The network 120 may be embodied as one or more wired networks, one or more wireless networks, or a combination of wired and wireless networks. Some non-exhaustive examples of the wired networks may include local area networks (LANs), Ethernet, optical networks, and the like. Some non-exhaustive examples of the wireless networks may include cellular networks (e.g. CDMA/GPRS/EDGE/3G/4G/LTE networks), wireless LANs (WLANs), Bluetooth or a Zigbee based networks, and the like. An example of the combination of the wired and wireless network may include the Internet. The processing of the plurality of records for assessing and managing risk is further explained with reference to FIG. 2.

FIG. 2 is a block diagram of a system 102 configured to facilitate management of health care risk exposure of an organization, in accordance with an example embodiment. The system 102 is depicted to include a communication interface 202, a document generator 204, a duplicate document identifier 206, an event creator 208, a taxonomy classifier 210 and an event analyzer 212. The various components of the system 102 may be implemented using hardware, software, firmware or a combination thereof.

The communication interface 202 includes appropriate communication means, such as transmission and reception antennas, channel encoding mechanisms, application programming interfaces (APIs) and the like, to communicate with the plurality of data sources, such as the data sources 104 to 110 explained with reference to FIG. 1. In some example embodiments, the communication interface 202 may include APIs to facilitate communication with client devices, such as electronic devices of users related to insurance carriers, risk managers, third-party risk administrators, and the like.

The communication interface 202 may facilitate reception of plurality of records associated with the organization from the data sources. As explained with reference to FIG. 1, the data sources may store a plurality of records of health related adverse events associated with an organization, which together configure the risk related data for an organization. Accordingly, the communication interface 202 is configured to receive the plurality of records from the data sources. Each record includes data in structured form. The communication interface 202 is configured to provision the plurality of records to the document generator 204.

The document generator 204 is configured to receive the plurality of records from the communication interface 202 and generate a set of composite documents. Each composite document from among the set of composite documents includes information in an unstructured form. More specifically, the document generator 204 is configured to generate free-text documents from the plurality of records. The free-text documents are composed of unstructured text (for instance, in form of a narrative).

In at least one example embodiment, the document generator 204 includes an unstructuring algorithm capable of removing a structure of data in each record to facilitate generation of the set of composite documents. For example, consider a dataset with three fields: Name, Description and Date. A first record includes values as: John, Fell down the stairs and got bruised, and 01/20/2016. The unstructuring algorithm combines the three fields into a composite document. The composite document then includes information in an unstructured form as follows:

Name=“John”|Description=“Fell down the stairs and got bruised”|Date=“01/20/2016”.

The document generator 204 is configured to provision the set of composite documents to the duplicate document identifier 206. The duplicate document identifier 206 is configured to determine if the set of composite documents includes instances of duplication of information. More specifically, the duplicate document identifier 206 identifies set of duplicates which relate to the same event. The identification of the set of duplicates is important as the duplicates bias the true distribution of the event. In at least one example embodiment, the duplicate document identifier 206 includes a deduplication algorithm capable of identifying instances of duplication of information in the set of composite documents. The deduplication algorithm may be configured to identify instances of duplication of information based on patient ID, provider ID, service date, sizable match in content (identified using matching sequence of words, etc.), and the like.

The duplicate document identifier 206 is configured to provision the identified instances of duplication of information to the event creator 208. The event creator 208 is configured to create events corresponding to the instances of duplication of information. In at least one example embodiment, a created event may correspond to an occurrence of an activity, for example in a hospital or a workplace setting, that triggered a medical malpractice or a worker's compensation action. In an embodiment, a list of event documents may be created.

The taxonomy classifier 210 configured to classify each created event using a predetermined taxonomy. Typically, taxonomy is a scheme of classification. Each event is classified, or more specifically each document associated with an event is tagged to the predetermined taxonomy. The taxonomy classifier 210 may include a taxonomy classification algorithm capable of generating a taxonomy based on user input as well as machine learning from prior classification of events.

In an embodiment, the taxonomy classification algorithm may be configured to classify each event based on the predetermined taxonomy using predefined rules and/or machine-learning algorithms. As explained above, events are created for each set of duplicates. Every event is attached to a taxonomy using a combination of rules and machine learning algorithms. It is noted that the rules are specific to the taxonomy. For instance, a rule may be framed as: If the composite document has the text “Statin”, place it in a taxonomy level corresponding to “Medicine”. Consequently, each event (i.e. each set of duplicates) is attached to a predetermined taxonomy.

The event analyzer 212 is configured to analyze the events classified by the taxonomy classifier 210 to facilitate assessment and management of health care risk exposure of the organization. More specifically, the events are analyzed to isolate interventions to design. The isolation of interventions to design involves reporting and analysis of the processed data. The event analyzer 212 may be configured to perform a variety of analysis on the processed data, such as for example, benchmarking, trend analysis, comparative analysis, and the like. In at least one example embodiment, each class within the taxonomy is associated with a set of interventions. The event analyzer 212 may be configured to analyze the set of interventions associated with a classified event to isolate key sources of risk. Such analysis may enable insurance carriers to develop loss control programs for insured entities. Similarly, such analysis may assist risk managers within the organizations to isolate key sources of risk and develop intervention strategies based on the analysis of the events.

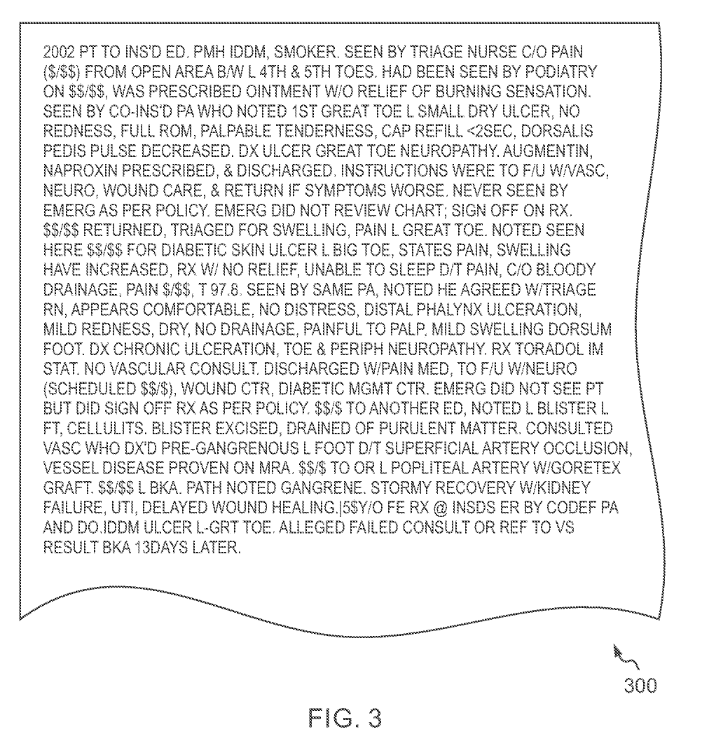

FIG. 3 illustrates an example composite document 300 generated by removing structure from one or more records by the document generator 204 of the system 102, in accordance with an example embodiment. As explained with reference to FIG. 2, the document generator 204 is configured to receive a plurality of records from the data sources. The document generator 204 includes an unstructuring algorithm configured to remove structure from records in structured form to generate a composite document. As can be seen the composite document 300 includes freeform text and the narrative form of the document facilitates ease of processing by various processing algorithms, such as deduplication algorithm and taxonomy classification algorithm.

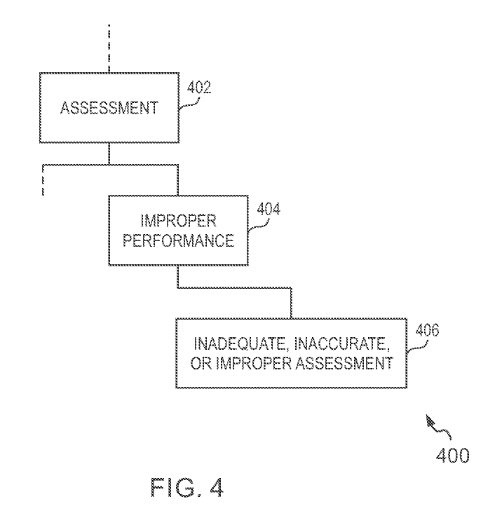

Further, as explained with reference to FIG. 2, the duplicate document identifier 206 of the system 102 is configured to identify instances of duplicate information, or in other words, identify set of duplicates and the event creator 208 is configured to create an event for each set of duplicates. The taxonomy classifier 210 is further configured to classify the event, i.e. attach the event document (i.e. set of duplicates) to the predetermined taxonomy based on predefined rules and/or machine learning algorithms. An example classification of the composite document 300 to a taxonomy class is depicted in FIG. 4.

FIG. 4 illustrates a portion 400 of an example taxonomy used for classifying the composite document 300, in accordance with an example embodiment. The composite document 300 shown in FIG. 3 may be classified using machine learning algorithm to a branch of the taxonomy as shown in FIG. 4. More specifically, the composite document 300 may be classified at a first level in the taxonomy under class 402 associated with a label ‘Assessment’, at a second level in the taxonomy under class 404 associated with a label ‘Improper Assessment’ and at a third level in the taxonomy under class 406 associated with the label ‘Inadequate, Inaccurate, or Improper Assessment’. The above taxonomy indicates the root causes of the risk at 3 levels. That is, the first level is Assessment, under Assessment is Improper Performance, and under Improper Performance is Inadequate, Inaccurate, or Improper Assessment. The events/composite documents classified in such a manner may be analyzed by the event analyzer 212 to isolate key sources of risk and recommend intervention strategies to risk managers, who may then develop loss control programs for the insured entities, thereby reducing health care exposure risks.

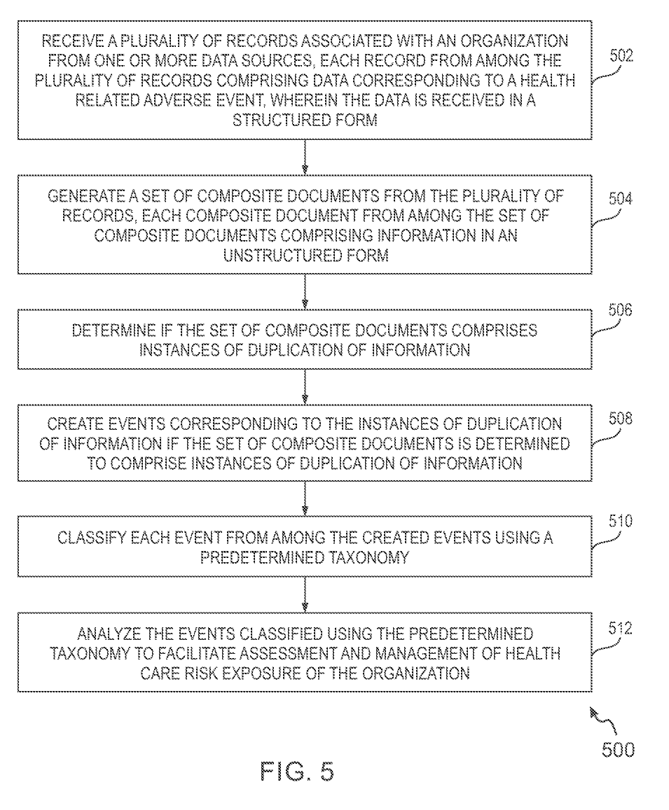

FIG. 5 is a flow diagram of a method 500 for facilitating management of health care exposure risk of an organization, in accordance with an example embodiment. The method 500, depicted in the flow diagram may be executed by, for example, the system 102 explained with reference to FIGS. 2-4. Operations of the flowchart, and combinations of operation in the flowchart, may be implemented by, for example, hardware, firmware, a processor, circuitry, and/or a different device associated with the execution of software that includes one or more computer program instructions for resolution of queries submitted by one or more users.

At operation 502 of the method 500, a plurality of records associated with an organization is received from one or more data sources. Each record includes information corresponding to a health related adverse event (for example, a sickness, a disease, physical or mental condition requiring medical assistance, a work-related injury, and the like). As explained with reference to FIG. 1, the plurality of records is stored in a structured form in the data sources. A communication interface of a device, such as the communication interface 202 of the system 102, may be configured to communicate with the plurality of data sources and receive the plurality of records.

At operation 504 of the method 500, a set of composite documents from the plurality of records is generated. The set of composite documents may be generated by a document generator, such as the document generator 204 of the system 102. The document generator may include an unstructuring algorithm configured to remove structure from individual records to generate a freeform or narrative form of document, referred to herein as a composite document. An example composite document generated from records received from the plurality of data sources is depicted in FIG. 3. As can be seen, the composite document includes record information in an unstructured form.

At operation 506 of the method 500, it is determined whether the set of composite documents includes instances of duplication of information or not. The determination may be performed by a duplicate document identifier, such as the duplicate document identifier 206 of the system 102. The duplicate document identifier may use a deduplication algorithm to determine whether the set of composite documents includes instances of duplication of information or not.

At operation 508 of the method 500, events corresponding to the instances of duplication of information are created if the set of composite documents is determined to include the instances of duplication of information. More specifically, an event is created for each set of duplicates within the set of composite documents. The events may be created by an event creator, such as the event creator 208 of the system 102. As explained with reference to FIG. 2, an event may correspond to an occurrence of an activity in a hospital or a workplace setting that triggered a medical malpractice or a worker's compensation action.

At operation 510 of the method 500, each event from among the created events is classified using a predetermined taxonomy. Typically, taxonomy is a scheme of classification. Each event is classified, or more specifically each document associated with an event is tagged to the predetermined taxonomy. The classification may be performed by a taxonomy classifier, such as the taxonomy classifier 210 of the system 102. The taxonomy classifier may include a taxonomy classification algorithm capable of generating a taxonomy based on user input as well as machine learning from prior classification of events.

In an embodiment, the taxonomy classification algorithm may be configured to classify each event based on the taxonomy using pre-defined rules and/or machine-learning algorithms. As explained above, events are created for each set of duplicates. Every event is attached to the predetermined taxonomy using a combination of rules and machine learning algorithms.

At operation 510 of the method 500, the events classified using the taxonomy are analyzed to facilitate assessment and management of health care risk exposure of the organization. More specifically, the events are analyzed to isolate interventions to design. The isolation of interventions to design involves reporting and analysis of the processed data. The analysis of events may be performed by an event analyzer, such as the event analyzer 212 of the system 102. The event analyzer may be configured to perform a variety of analysis on the processed data, such as for example, benchmarking, trend analysis, comparative analysis, and the like. In at least one example embodiment, each class within the predetermined taxonomy is associated with a set of interventions. The event analyzer may be configured to analyze the set of interventions associated with a classified event to isolate key sources of risk. Such analysis may enable insurance carriers to develop loss control programs for insured entities. Similarly, such analysis may assist risk managers within the organizations to isolate key sources of risk and develop intervention strategies based on the analysis of the events.

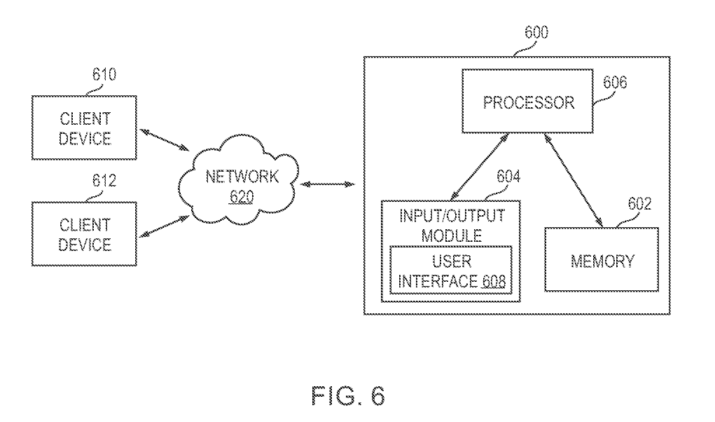

FIG. 6 illustrates a server 600 capable of implementing the various embodiments of the present disclosure. The server 600 is depicted to include a memory 602, an input/output (I/O) module 604 and at least one processor 606 for facilitating management of health care risk exposure of an organization.

The processor 606 is communicably coupled with the memory 602 and the I/O module 604. The processor 606 is capable of executing the stored machine executable instructions in the memory 602 or within the processor 606 or any storage location accessible to the processor 606. The processor 606 is configured to perform the various functionalities of the system 102 as described herein. More specifically, the processor 606 is configured to perform the functionalities performed by the communication interface 202, the document generator 204, the duplicate document identifier 206, the event creator 208, the taxonomy classifier 210 and the event analyzer 212 as explained with reference to FIGS. 2 to 4 and is not explained again herein.

The processor 606 may be embodied in a number of different ways. In an embodiment, the processor 606 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The memory 602 is a storage device embodied as one or more volatile memory devices, one or more non-volatile memory devices, and/or a combination of one or more volatile memory devices and non-volatile memory devices, for storing micro-contents information and instructions. The memory 602 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.). The memory 602 may be configured to store the various algorithms such as the unstructuring algorithm, deduplication algorithm, taxonomy classification algorithm, and the like. The processor 606 may be configured to execute the algorithms as explained with reference to FIG. 2. Additionally, the memory 602 may be configured to store the taxonomy, the pre-defined rules and/or machine learning algorithms for facilitating classification of event documents, and the like.

In an embodiment, the I/O module 604 may include mechanisms configured to receive inputs from and provide outputs to the user of the server 600. To that effect, the I/O module 604 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display such as User Interface 608 (such as a light emitting diode display, a thin-film transistor (TFT) display, a liquid crystal display, an active-matrix organic light-emitting diode (AMOLED) display, etc.), a microphone, a speaker, a ringer, a vibrator, and the like. Users of the server 600, such as risk managers, insurance carrier personnel, and third-party risk administrators may utilize their respective electronic devices (exemplarily depicted as client devices 610 and 612) to access the user interface 608 of the I/O module 604 and interact with the server 600 to assess and manage health care risk exposure of their respective organizations.

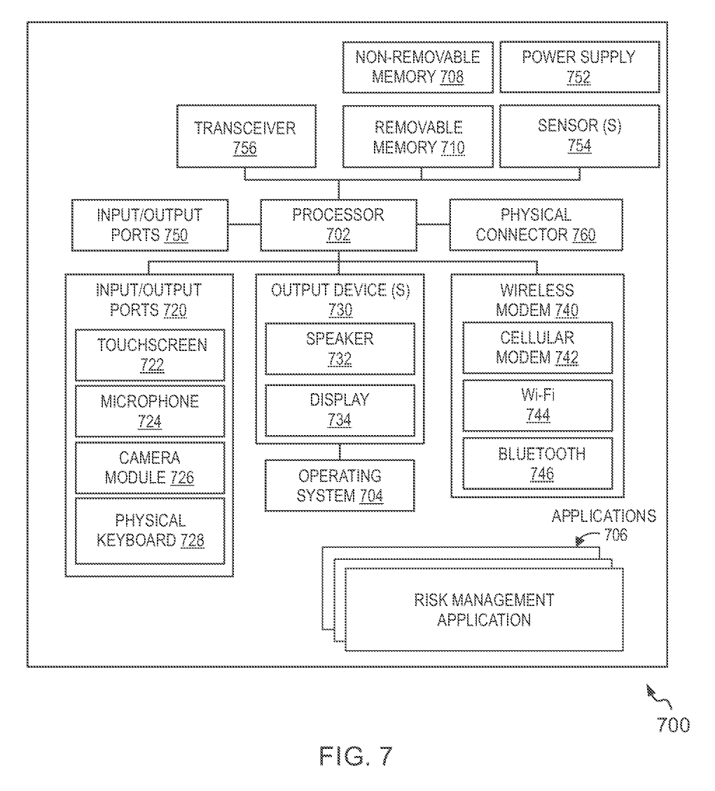

FIG. 7 illustrates a computing device 700 capable of implementing the various embodiments of the present disclosure. In an embodiment, the various operations performed by the system 102 may be implemented using an application in a computing device, such as the computing device 700.

It should be understood that the computing device 700 as illustrated and hereinafter described is merely illustrative of one type of device and should not be taken to limit the scope of the embodiments. As such, it should be appreciated that at least some of the components described below in connection with that the computing device 700 may be optional and thus in an example embodiment may include more, less or different components than those described in connection with the example embodiment of the FIG. 7. As such, among other examples, that the computing device 700 could be any of a mobile electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated computing device 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the computing device 700 and support for one or more applications programs (see, applications 706), such as a risk management application, that implements one or more of the innovative features described herein. In addition to risk management application, the applications 706 may include common mobile computing applications (e.g., telephony applications, email applications, calendars, contact managers, web browsers, messaging applications) or any other computing application. The risk management application, in at least one example embodiment, may be configured to provide the logic to process the plurality of records associated with the organization to facilitate assessment and management of health care risk exposure of the organization, as explained with reference to FIGS. 2 to 4.

The illustrated computing device 700 includes one or more memory components, for example, a non-removable memory 708 and/or removable memory 710. The non-removable memory 2408 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704 and the applications 706.

The computing device 700 can support one or more input devices 720 and one or more output devices 730. Examples of the input devices 720 may include, but are not limited to, a touch screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited to a speaker 732 and a display 734. Other possible output devices (not shown in the FIG. 7) can include piezoelectric or other haptic output devices. Some devices can serve more than one input/output function. For example, the touchscreen 722 and the display 734 can be combined into a single input/output device.

A wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device or a local wireless data network or router, and/or a Bluetooth-compatible modem 746. The wireless modem 740 is typically configured for communication with one or more cellular networks, such as a GSM network for data and voice communications within a single cellular network, between cellular networks, or between the computing device 700 and a public switched telephone network (PSTN).

The computing device 700 can further include one or more input/output ports 750, a power supply 752, one or more sensors 754 for example, an accelerometer, a gyroscope, a compass, or an infrared proximity sensor for detecting the orientation or motion of the computing device 700, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

Various embodiments of the present technology provide a method, system and computer program product that are capable of overcoming drawbacks of conventional risk management solutions. More specifically, various embodiments of the present technology facilitate management of health care risk exposures of organizations. The techniques disclosed herein enable combination of heterogeneous data sets and provide the organization with a consolidated view of their health care risk exposure. The techniques suggested herein may be beneficial for a variety of users, such as insurance carriers, risk managers and third-party administrators. The insurance carriers may use the techniques disclosed herein to develop loss control programs for the insured entities. Further, the insured entities may be provided with benchmarking analysis along with inputs to pricing models. The risk managers may use the techniques disclosed herein to isolate key sources of risk and develop appropriate intervention strategies/loss control programs. Similarly, the third-party risk administrators may use the techniques to develop differentiated strategies for their clients based on type of the risk.

The embodiments illustrated and described herein as well as embodiments not specifically described herein but within the scope of aspects of the invention constitute exemplary system means for facilitating management of health care risk exposure of an organization. For example, the elements illustrated and described with reference to FIGS. 2 to 4, when configured, under control of the processor, such as the processor 606 and computer program code in the memory 602 to perform the operations illustrated and described with reference to FIGS. 2 to 4, constitute means for receiving a plurality of records associated with an organization from one or more data sources, each record from among the plurality of records comprising data corresponding to a health related adverse event, wherein the data is received in a structured form; means for generating a set of composite documents from the plurality of records, each composite document from among the set of composite documents comprising information in an unstructured form; means for determining if the set of composite documents comprises instances of duplication of information; means for creating events corresponding to the instances of duplication of information if the set of composite documents is determined to comprise instances of duplication of information; means for classifying each event from among the created events using a predetermined taxonomy; and means for analyzing the events classified using the predetermined taxonomy to facilitate assessment and management of health care risk exposure of the organization.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the system 102, the communication interface 202, the document generator 204, the duplicate document identifier 206, the event creator 208, the taxonomy classifier 210, the event analyzer 212, the processor 606, the memory 602 and the I/O module 604 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIG. 5). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for facilitating management of health care risk exposure of an organization, the method comprising:
receiving, by a processor, a plurality of records associated with an organization from one or more data sources, each record from among the plurality of records comprising data corresponding to a health related adverse event, wherein the data is received in a structured form;
generating, by the processor, a set of composite documents from the plurality of records, each composite document from among the set of composite documents comprising information in an unstructured form;
determining, by the processor, if the set of composite documents comprises instances of duplication of information;
creating, by the processor, events corresponding to the instances of duplication of information if the set of composite documents is determined to comprise instances of duplication of information;
classifying, by the processor, each event from among the created events using a predetermined taxonomy; and
analyzing, by the processor, the events classified using the predetermined taxonomy to facilitate assessment and management of health care risk exposure of the organization.

2. The method as claimed in claim 1, wherein a record corresponds to a claim, a complaint or an incident in a workplace setting related to the organization.

3. The method as claimed in claim 1, further comprising:
removing a structure of data in each record from among the plurality of records by the processor using an unstructuring algorithm to facilitate generation of the set of composite documents.

4. The method as claimed in claim 1, wherein a deduplication algorithm is used by the processor to identify instances of duplication of information in the set of composite documents.

5. The method as claimed in claim 1, wherein at least one event from among the created events corresponds to an occurrence of an activity that triggered a medical malpractice or a worker's compensation action.

6. The method as claimed in claim 1, further comprising:
classifying the each event based on the predetermined taxonomy using at least one of predefined rules and machine-learning algorithms.

7. The method as claimed in claim 1, wherein analyzing the events comprises performing at least one of benchmarking analysis, trend analysis and comparative analysis.

8. The method as claimed in claim 1, further comprising facilitating at least one of:
development of loss control programs for insured entities by the insurance carriers based on the analysis of the events; and
isolation of key sources of risk and development of intervention strategies by the risk managers based on the analysis of the events.

9. A system for facilitating management of health care risk exposure of an organization, the system comprising:
a communication interface configured to receive a plurality of records associated with an organization from one or more data sources, each record from among the plurality of records comprising data corresponding to a health related adverse event, wherein the data is received in a structured form;
a document generator configured to receive the plurality of records from the communication interface and generate a set of composite documents, wherein each composite document from among the set of composite documents comprises information in an unstructured form;
a duplicate document identifier configured to determine if the set of composite documents comprises instances of duplication of information;
an event creator configured to create events corresponding to the instances of duplication of information if the set of composite documents is determined to comprise instances of duplication of information by the duplicate document identifier;
a taxonomy classifier configured to classify each event from among the created events using a predetermined taxonomy; and
an event analyzer configured to analyze the events classified by the taxonomy classifier to facilitate assessment and management of health care risk exposure of the organization.

10. The system as claimed in claim 9, wherein a record corresponds to a claim, a complaint or an incident in a workplace setting related to the organization.

11. The system as claimed in claim 9, wherein the document generator comprises an unstructuring algorithm capable of removing a structure of data in each record from among the plurality of records to facilitate generation of the set of composite documents.

12. The system as claimed in claim 9, wherein the duplicate document identifier comprises a deduplication algorithm capable of identifying instances of duplication of information in the set of composite documents.

13. The system as claimed in claim 9, wherein at least one event from among the created events corresponds to an occurrence of an activity that triggered a medical malpractice or a worker's compensation action.

14. The system as claimed in claim 9, wherein the taxonomy classifier is configured to classify the each event based on the predetermined taxonomy using at least one of predefined rules and machine-learning algorithms.

15. The system as claimed in claim 9, wherein the event analyzer is configured to facilitate at least one of:
development of loss control programs for insured entities by the insurance carriers based on the analysis of the events; and
isolation of key sources of risk and development of intervention strategies by the risk managers based on the analysis of the events.

16. A computer program product comprising at least one computer-readable storage medium, the computer-readable storage medium comprising a set of instructions which, when executed by one or more processors, cause an electronic device to:
receive a plurality of records associated with an organization from one or more data sources, each record from among the plurality of records comprising data corresponding to a health related adverse event, wherein the data is received in a structured form;
generate a set of composite documents from the plurality of records, each composite document from among the set of composite documents comprising information in an unstructured form;
determine if the set of composite documents comprises instances of duplication of information;
create events corresponding to the instances of duplication of information if the set of composite documents is determined to comprise instances of duplication of information;
classify each event from among the created events using a predetermined taxonomy; and
analyze the events classified using the predetermined taxonomy to facilitate assessment and management of health care risk exposure of the organization.

17. The computer program product as claimed in claim 16, wherein a record corresponds to a claim, a complaint or an incident in a workplace setting related to an organization, and, wherein at least one event from among the created events corresponds to an occurrence of an activity that triggered a medical malpractice or a worker's compensation action.

18. The computer program product as claimed in claim 16, wherein the electronic device is further caused to:
remove a structure of data in each record from among the plurality of records using an unstructuring algorithm to facilitate generation of the set of composite documents.

19. The computer program product as claimed in claim 16, wherein the electronic device is further caused to:
use a deduplication algorithm to identify instances of duplication of information in the set of composite documents; and
classify each event based on the predetermined taxonomy using at least one of predefined rules and machine-learning algorithms

20. The computer program product as claimed in claim 16, wherein the electronic device is further caused to facilitate:
development of loss control programs for insured entities by the insurance carriers based on the analysis of the events; and
isolation of key sources of risk and development of intervention strategies by the risk managers based on the analysis of the events.
